(19) United States
(12) Patent Application Publication
(10) Pub. No.: US 2016/0237380 A1
(43) Pub. Date: Aug. 18, 2016

(54) SET, COMPRISING A CLOTH AND A LIQUID, AND COMPOSITION FOR THE HYDROPHILIZATION OF SURFACES

(71) Applicant: CARL FREUDENBERG KG, Weinheim (DE)

(72) Inventors: Norbert Weis, Weinheim (DE); Karl-Ludwig Gibis, Limburgerhof (DE); Joerg Hausdorf, Rimbach (DE); Friedel Winterling, Ludwigshafen (DE)

(21) Appl. No.: 15/027,721

(22) PCT Filed: Aug. 25, 2014
(86) PCT No.: PCT/EP2014/002267

§ 371 Date: Apr. 7, 2016

(30) Foreign Application Priority Data
Oct. 11, 2013 (DE) 10 2013 016 934.8
Apr. 15, 2014 (DE) 10 2014 005 518.3

(51) Int. Cl. C11D 3/37; B08B 1/00; B08B 3/10; B08B 17/02; C11D 3/43; C11D 1/66

(52) U.S. Cl. CPC C11D 3/3773; C11D 3/43; C11D 1/66; C11D 1/662; B08B 3/10; B08B 17/02; B08B 1/006; Y10T 442/626

(57) ABSTRACT

A set for surface treatment purposes, has a textile fabric and a container which holds a liquid, such that a surface can be hydrophilized, wherein the liquid contains at least one hydrophilizing polymer and has a pH value of less than 7. A related composition has: a) 0.05 to 1% by weight of at least one hydrophilizing copolymer with, in the form of polymerized units, at least one amino-functional monomer which has a permanent cationic charge or which is capable of forming a cationic charge through protonation, and at least one acidic monomer which has a permanent anionic charge or which is capable of forming an anionic charge; b) 0.5 to 1.4% by weight of at least one non-ionic surfactant; c) 1 to 10% by weight of at least one solvent; d) with the remainder being water.

### CROSS-REFERENCE TO RELATED APPLICATIONS

This application is a U.S. national stage application under 35 U.S.C. §371 of International Application No. PCT/EP2014/002267, filed on Aug. 25, 2014, and claims benefit to German Patent Applications No. DE 10 2013 016 934.8, filed on Oct. 11, 2013, and DE 10 2014 005 518.3, filed on Apr. 15, 2014. The International Application was published in German on Apr. 16, 2015, as WO 2015/051864 A1 under PCT Article 21(2).

### FIELD

This invention relates to a set for surface treatment.

### BACKGROUND

Sets of this general type are already known in the art.

It is known to market cloths or sponges together with cleaning or polishing compositions.

However, there is a need for sets whereby a surface may be rendered hydrophilic as effectively as possible, so that typical household dirt, e.g., oily/greasy films and also limescale and soap scum, cannot adhere thereto and water can sheet off and dry off.

The liquid shall further be capable of application to the surface in a convenient and economical manner.

Commercial cleaning agent formulations provide effective cleaning of hard surfaces, for example in industry, the home or social amenities. They generally consist of an aqueous solution of surfactants, in particular nonionic and anionic surfactants. One or more alcohols are optionally included to facilitate drying, and sequestrants and bases may be employed to establish the pH.

An essential disadvantage of these cleaning agents formulations is that they do not change the surface tension of the treated surfaces in a sustained manner. Water coming into contact with the hard surface, as for example rainwater in the case of windowpanes, or tap water on bathroom tiles, may dry leaving behind spots or trace deposits. These trace deposits are the result of water droplets in contact with hard surfaces contracting to form beads. These beads, as they dry on the surface, leave behind traces in the original shape of the beads.

Cleaning solutions on offer to resolve this issue increase the hydrophilicity of the surface in order to minimize the contact angle between the water droplet and the hard surface to be treated.

So, for example, WO 2009/023209 describes a cleaning composition comprising
a) about 0.05 to about 1 weight percent of a hydrophilic polymer comprising
   (1) an acidic anionic monomer;
   (2) a cationic monomer having a permanent cationic charge and/or capable of forming such a charge upon protonation, and
   (3) optionally, a monomer having a neutral charge;
b) about 1.5 to about 5 weight percent of at least one surface-active substance comprising at least one alkoxylated alcohol;
c) about 1 to about 4 weight percent of at least one solvent;
d) a balance of water.

It is essential for the composition that it is free from anionic, cationic or amphoteric surface-active substances.

The cleaning solution described provides a cleaning of hard surfaces and simultaneously the formation of a hydrophilic coating whereby the surface dries off rapidly. However, the composition is disadvantageous in that the relatively high surfactant concentration develops a lot of foam upon application. This compromises uniform distribution of the composition on the treated surface, and streaks or bubbles may form on the surface. In addition, a comparatively high amount of cleaning agent is needed for uniform treatment of the surface because of the high proportion of foam.

### SUMMARY

An aspect of the invention provides a set for surface treatment, the set comprising: a textile fabric; and a container which holds a liquid, wherein the liquid comprises a hydrophilicizing polymer, and wherein the liquid has a pH of below 7.

### BRIEF DESCRIPTION OF THE DRAWINGS

The present invention will be described in even greater detail below based on the exemplary FIGURE. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawing which illustrates the following:

FIG. 1 shows a set comprising a closed container for liquid and a cloth.

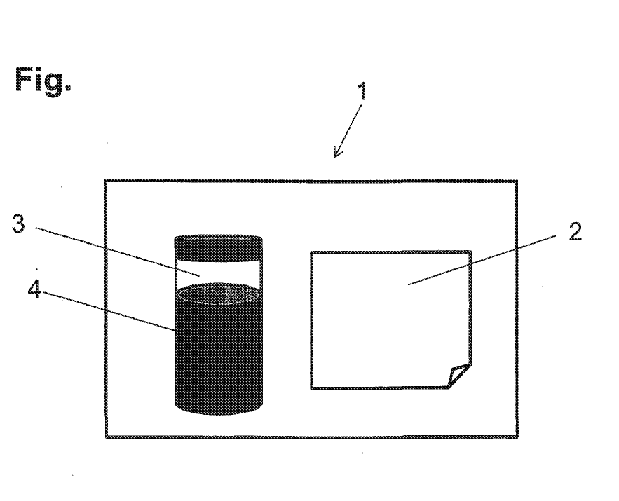

### DETAILED DESCRIPTION

An aspect of the present invention also relates to a composition for the treatment of hard surfaces, for example mirrors, tiling and shower walls. The composition should preferably endow these surfaces with hydrophilic properties.

An aspect of the invention more particularly relates to a composition comprising cleaning substances in combination with specific polymers that bestow hydrophilicizing properties to hard surfaces. These hydrophilicizing properties are effective in preventing the occurrence of trace deposits, for example due to the drying of deposited droplets of water.

An aspect of the present invention is develops a set of the type referred to at the outset such that a surface may be hydrophilicizable therewith in as effective and convenient manner as possible.

An aspect of the present inventors recognized that the textile fabric and the liquid have to be aligned with each other so as to maximize the hydrophilicizing polymer available for the surface treatment and to minimize the hydrophilicizing polymer absorbed in the fabric. Surprisingly, an acidic rendition of the liquid is found to ensure that polymers are scarcely absorbed in the fabric and are accordingly available for interacting with the surface. This provides for economy in the use of the liquid, since the fabric need not be fully saturated with liquid in order to provide polymer for the surface. Hence a set of the type referred to at the outset has been further developed such that a surface is hydrophilizable therewith in as effective and convenient a manner as possible.

As a result, the problems referred to Background can be solved.

The textile fabric may comprise microfibers. This makes for very uniform and very substantially nonstreaking distribution of the liquid over the surface. It was further found that usage of microfibers makes for particularly good and long-lasting hydrophilicizing effects because they remove soils, in particular those having hydrophobic properties, which adversely affect the adherence of the polymers to the surfaces to be treated.

The microfibers could be produced by a splitting process. Microfibers found to be particularly suitable are produced by a splitting process from a material selected from the group polyester, polyamide or a combination thereof. These microfibers are effective in ridding the surfaces of troublesome soils. Surprisingly, they are also suitable in the set described herein for also making the hydrophilicizing polymers present in the liquid available for the interaction with the treated surface in an efficient manner.

The proportion of said textile fabric that is polyester is more than 60 weight percent based on said textile fabric in a dry state. These proportions of polyester promote the above-described effect of the hydrophilicizing polymers being made available from the liquid by the fabric.

The hydrophilicizing polymer could comprise positively charged groups. Surface effects shown by such polymers are particularly good. They are notable for rapid and sustained interaction with the treated surface.

The positively charged groups are at least partly produced by protonation in an aqueous medium. It is advantageous for the positively charged groups to be at least partly generated by protonation in the liquid. The acidic pH range at the same time serves to deactivate electron-rich molecular positions in the textile fabric in respect of the absorption of the polymer. This leads to a nearly complete availability of the hydrophilicizing polymer for the surface to be treated therewith.

The hydrophilic effect of the treated surface, moreover, is particularly resistant in these cases to washing off with neutral solvents upon further usage of the surface. It has been determined that pH values in the range between 2 and 5 are particularly suitable in that protonation is sufficient without even acid-sensitive surfaces being damaged by the liquid in the course of the method described. Against this background, the pH of the liquid could be between 2 and 5.

The textile fabric could be configured as a cloth. Cloths will readily fold and drape.

A method for treating a surface could comprise the steps of:
a) providing a set as claimed in any preceding claim,
b) applying said liquid to the surface to be treated, and
c) distributing said applied liquid using said textile fabric.

Using such a method, troublesome dirt such as greases is durably removable from a surface while at the same time the hydrophilicizing polymers are provided.

There is also a need to provide a composition that does not have the disadvantages of the prior art which were identified at the outset.

This need is met according to the invention by a composition comprising:
a) 0.05-1 wt % of at least one hydrophilicizing copolymer comprising in the form of polymerized units:
   at least one amino-functional monomer having a permanent cationic charge or capable of forming a cationic charge by protonation;
   at least one acidic monomer having a permanent anionic charge or capable of forming an anionic charge;
b) 0.5 to 1.4 wt % of at least one nonionic surfactant;
c) 1 to 10 wt % of at least one solvent;
d) a balance of water.

It is an essential feature of the composition according to the present invention that it includes a comparatively low proportion of surfactants. As a result, the composition develops but little foam upon application, thereby ensuring uniform comprehensive distribution of the composition on the surface to be treated and avoiding the formation of streaks or bubbles. The composition of the present invention thus provides surfaces a homogeneous, uninterrupted coating which, furthermore, is notable for good durability. In addition, the drying time exhibited by the surfaces treated is but extremely short. At the same time, despite its low level of surfactants, the composition of the invention provides a satisfactory cleaning performance.

The composition of the present invention accordingly makes possible efficient cleaning of a very wide variety of hard surfaces, such as glass, ceramic, chrome, steel for example, while at the same time providing them a uniform hydrophilic surface coating. Furthermore, the coating makes it possible to avoid the occurrence of trace deposits, in particular due to the drying of water droplets deposited on said surface, and to reduce the time for drying.

A further special property of the coating formed by the composition according to the present invention is that it is additionally effective in preventing the steaming up of surfaces. Combined with the low surfactant concentration, therefore, the composition according to the present invention is very useful for the nonstreaky treatment of surfaces in wetrooms, for example mirrors.

It was further found that, surprisingly, even various plastics can be treated with the composition of the present invention.

Without wishing to be bound by any theory, it is believed that the improved properties of the composition according to the present invention are at least partly attributable to the reduced proportion of surfactants, as compared with the composition known from WO 2009/023209, entailing a reduced level of foaming upon application. This reduced level of foaming makes it possible to distribute the composition in a more uniform manner, without streaking.

The composition in the present invention contains from 0.5 to 1.4 wt % of at least one nonionic surfactant. This may be a single surfactant or mixtures of various nonionic surfactants. Suitable are, for example, condensation products of alkylene oxide, in particular ethylene oxide, with alcohols, polyols, alkylphenols, fatty acid esters, fatty acid amides and fatty amines; the amine oxides, the sugar derivatives, such as the alkylpolyglycosides or the esters of fatty acids and sugars, in particular sucrose monopalmitate; the tertiary phosphine oxides having a long chain; the dialkyl sulfoxides; the block copolymers of polyoxyethylene and polyoxypropylene; the polyalkoxyesters of sorbitan; the sorbitan fatty acid esters, the poly(ethylene oxide)s and fatty acid amides modified to endow them with a hydrophobic character (for example the mono-and diethanolamides of fatty acids having 10 to 18 carbon atoms).

Likewise suitable are the polyoxyalkylene-(polyethoxyethylene-, polyethoxypropylene-, polyoxybutylene-)alkylphenols with C6-C12-alkyl substituent and 5 to 25 oxyalkylene units; the glucosamides, glucamides, glyceramides; the aliphatic C8-C22-polyoxyalkylene alcohols having 1 to 25 oxyalkylene units (oxyethylene, oxypropylene), the amine oxides, such as the C10-C18-alkyl dimethylamine oxides, the C8-C22-alkoxyethyldihydroxyethylamine oxides; the alkylpolyglycosides described in U.S. Pat. No. 4,565,647, the C8-C20-fatty acid amides; the ethoxy fatty acids; the ethoxyamines.

Alkylpolyglycosides are likewise suitable. They are surfactants obtainable by the reaction of sugars and alcohols by the pertinent methods of preparative organic chemistry, a mixture of monoalkylated, oligomeric or polymeric sugars being obtained depending on the manner of synthesis. Preferred alkylpolyglycosides are the alkylpolyglucosides, particular preference being given to the alcohol being a long-chain fatty alcohol or a mixture of long-chain fatty alcohols with branched or unbranched C8-to C18-alkyl chains and the degree of oligomerization (DP) of the sugars being between 1 and 10, preferably 1 to 6, in particular 1.1 to 3, extremely preferably 1.1 to 1.7, for example C8-10-alkyl-1.5-glucoside (DP of 1.5).

Further nonionic surfactants for the purposes of the invention may be alkoxylates such as polyglycols ethers, fatty alcohol polyglycols ethers (fatty alcohol alkoxylates), alkylphenol polyglycols ethers, endcapped polyglycols ethers, mixed ethers and hydroxyl mixed ethers and fatty acid polyglycols esters. It is likewise possible to use ethylene oxide, propylene oxide, block polymers and fatty acid alkanolamides and fatty acid polyglycols ethers. Similarly, further sugar surfactants (polyol surfactants), for instance fatty acid glucamides, are employable.

Preferred fatty alcohol polyglycols ethers are branched or unbranched, saturated or unsaturated C8-22 alcohols alkoxylated with ethylene oxide (EO) and/or propylene oxide (PO) where the degree of alkoxylation is up to 30, preferably ethoxylated C10-18 fatty alcohols where the degree of ethoxylation is less than 30, preferably from 1 to 20, more preferably from 1 to 12, yet more preferably from 1 to 8, for example C12-14 fatty alcohol ethoxylates with 8 EO.

In a preferred embodiment of the invention, the surfactant is selected such that as a single surfactant or a mixture of various surfactants, it has a foam volume below 400 ml, preferably less than 300 ml, as per EN 12728 (1 g/L, 20° C., 30 s, demin. water).

As mentioned, developing a minimal volume of foam is advantageous because, as a result, very uniform distribution of the composition on the surface to be treated is obtained and the formation of streaks or bubbles is avoided. In addition, compositions having a lower volume of foam develop a homogeneous layer on the surface within a shorter time. This is advantageous because, for example, any further intended steps of treating the surface can take place earlier.

Particular usefulness for the purposes of the present invention as low-foam nonionic surfactants and/or low-foam mixtures of nonionic surfactants of the type described above extends to alcohol alkoxylates, for example available under the name of Dehypon, Synperonic, Dowfax, Plurafac LF and alcohol ethoxylates, preferably comprising 8-15 carbon atoms, more preferably 8-12 carbon atoms, for example available under the name of Lutensol; ethylene/propylene oxide block copolymers, for example available under the name of Pluronic from BASF; Dehypon, for example available from BASF, Synperonic, for example available from Croda, Dowfax, for example from Dow Chemical, Plurafac, for example available from BASF. A particularly preferred low-foam nonionic surfactant is Lutensol XL 70 available from BASF.

Particularly preferred mixtures of nonionic surfactants contain one or more of the abovementioned low-foam surfactants and an alkylpolyglycoside, for example an alkylpolyglycoside marketed by BASF under the name of Glucopon. Preferred mixing ratios range from 3:1 to 1:2 (low-foam surfactant: alkylpolyglycoside), while mixing ratios of from 2:1 to 1:1 (low-foam surfactant: alkylpolyglycoside) are particularly preferable, the low-foam surfactants and mixing ratios preferably being chosen so that the foam volume stays below 400 ml (as described above, 1 g as sum total of the two surfactants). A particularly preferred alkylpolyglycoside is Glucopon 215 UP from BASF. A particularly preferred combination of surfactants consists of Lutensol XL 70 and Glucopon 215 UP in a ratio of from 2:1 to 1:1 subject to the proviso that the total amount of surfactant does not exceed 1.2% in the overall formulation.

In one preferred embodiment of the invention, the surfactant comprises alkoxylated alcohol. Said alkoxylated alcohol preferably comprises 8-15 carbon atoms, preferably 8-12 carbon atoms. Using an ethoxylated alcohol is preferable for the purposes of the present invention. Commercially available surfactants particularly suitable for the purposes of the present invention are for example marketed under the brand name LUTENSOL XL70® or Lutensol XL80®.

Practical tests have shown that the proportion of surfactant in the composition according to the present invention is advantageously established at from 0.1 to 1.3%, preferably at from 0.5 to 1.3% and especially from 0.5 to 0.8%.

A further essential component of the composition according to the present invention is the hydrophilicizing copolymer comprising the following monomers in the form of polymerized units:
at least one amino-functional monomer
at least one, preferably hydrophilic, acidic monomer.

A hydrophilicizing copolymer for the purposes of the present invention is a polymer imparting hydrophilic properties to customary surfaces, for example glass, ceramic, chrome, steel.

Hydrophilicizing copolymers suitable for the purposes of the present invention include, for example, copolymers formed from acrylic or methacrylic acid and MAPTAC (methacryloylaminopropyltrimethylammonium chloride, 3-trimethylammonium propyl methacrylamide chloride), DADMAC (diallyldimethylammonium chloride) or some other polymerizable quaternary ammonium compound. It is further also possible to use copolymers with AMPS (2-acrylamido-2-methylpropanesulfonic acid). Amino-functionalized polyether siloxanes, i.e., copolymers of polymethylsiloxanes with ethylene oxide or propylene oxide segments are further suitable polymers.

In one preferred embodiment of the invention, the amino-functional monomer is methacrylamido(propyl)trimethylammonium chloride. Good results are further obtained on employing acrylic acid and/or methacrylic acid as hydrophilic acidic monomer.

In a further preferred embodiment of the invention, the hydrophilicizing copolymer is a quaternized ammonium/acrylamide/acrylic acid copolymer and, in particular, a diallyldimethylammonium chloride/acrylamide/acrylic acid copolymer.

The hydrophilicizing copolymer may also contain further monomers, for example uncharged hydrophilic monomers, in the form of polymerized units.

Exemplary hydrophilicizing copolymers suitable for the purposes of the present invention are described in the printed publications U.S. Pat. No. 6,569,261, U.S. Pat. No. 6,593,288, U.S. Pat. No. 6,703,358 and U.S. Pat. No. 6,767,410.

Particularly suitable polymers for the purposes of the present invention are for example available under the trade names of Mirapol Surf-S 100, 110, 200, 210, 400, 410, A 300, A 400 (Rhodia). Likewise suitable polymers are commercially available for example under the trade name of Polyquart Ampho 149 (Cognis).

The proportion of hydrophilicizing copolymer in the composition of the present invention is preferably in the range from 0.05 to 0.50 wt %, more preferably in the range from 0.10 to 0.30 wt % and yet more preferably in the range from 0.15 to 0.20 wt %.

Advantageously, the weight ratio of hydrophilic copolymer to surfactant is between 1 to 2 and 1 to 50, advantageously between 1 to 2 and 1 to 10 and especially between 1 to 2 and 1 to 7.

The solvents typically used for the cleaning of hard surfaces are usable for the composition of the present invention. Suitable have been found to be, for example, mono-, di-and/or trialkylene glycol ethers and diethers, particularly mono-, di-and/or triethylene glycol ethers and diethers and mono-, di-and/or tripropylene glycol ethers and diethers. The alkyl chains therein may differ in chain length. Methyl, ethyl, propyl, butyl and hexyl are suitable for example.

Likewise suitable have proved to be glycols (e.g., dodecaneglycol and propanediol), alkoxylated glycols (e.g., methoxyoctanedecanol and ethoxyethoxyethanol), benzyl alcohol, aliphatic branched alcohols (e.g., 2-methylbutanol and 2-ethylbutanol), alkoxylated aliphatic branched alcohols (e.g., 1-methylpropoxyethanol and 2-methoxybutoxyethanol), alkoxylated linear C1-C5 alcohols (e.g., n-BPP or butoxypropoxypropanol, butoxyethanol, butoxypropanol, ethoxyethanol or mixtures thereof), linear C1-C5 alcohols (e.g., ethanol, propanol or mixtures thereof), dibutyl glycol ether and butyl triglycol ether.

Ethanol and isopropanol are particularly preferred solvents for the purposes of the present invention. The proportion of solvent in the composition of the present invention is in the range from 1 to 10 wt %, preferably from 3 to 7 wt % and especially from 4 to 6 wt %.

In one preferred embodiment of the invention, the composition of the present invention further includes an acid to establish the pH at from 2 to 5. The pH is preferably in the range from 2.3 to 4 and more preferably in the range from 2.8 to 3.5.

Useful acids include, for example, mono-, di-and tricarboxylic acids and/or mixtures thereof. These acids may also be mixed with inorganic acids. Examples of suitable organic acids include acetic acid, formic acid, lactic acid, hydroxyacetic acid, propionic acid, citric acid, adipic acid, glutaric acid, succinic acid and mixtures thereof and also tartaric acid, fumaric acid, gluconic acid and glutamic acid.

The composition of the present invention may additionally contain further customary ingredients, in particular further surfactants, such as: nonionic surfactants, such as the amine oxides, the alkylglucamides, the oxyalkylene derivatives of fatty alcohols, the alkylamides, the alkanolamides, amphoteric or zwitterionic surfactants, noncationic bactericides or disinfectants, such as triclosan, synthetic cationic polymers, polymers to police the viscosity of the mixture and/or the stability of the foams formed in use, hydrotropic agents, hydrating or moisture-donating agents or skin-protective agents, dyes, scents, preservatives.

A further aspect of the invention consists in using a composition as defined above to treat, particularly to hydrophilicize and/or externally clean hard surfaces, in particular glass, ceramic, chrome, steel and/or plastic, for example of mirrors, tiling and/or shower walls.

Practical tests have shown that a particularly good cleaning performance is obtainable from using the composition of the present invention when said composition is applied using a microfiber cloth. The fine microfibers endow the cloth with an extremely large surface area comprising fine pores and capillaries, which lead to a particularly good level of soil pickup. The present invention thus further provides a set comprising a composition according to the present invention and a microfiber cloth.

At the same time, it is with the aid of the microfiber cloth that the composition of the present invention can be applied to and distributed on the to-be-treated surface in a particularly uniform manner. It is believed that the good results come about because microfiber cloths combine a very finely textured surface with a multiplicity of small pores. This construction makes it possible for the cleaning liquid to form a film out of microdroplets that is deliverable to the surface very uniformly in one homogeneous layer.

Preferably, the microfiber cloth comprises melt-spun, aerodynamically attenuated composite filaments having a linear density of 1.5 to 3 dtex and directly laid down to form a nonwoven web, wherein the composite filaments have at least 80% split into elementary filaments having a linear density of 0.05 to 1.0 dtex and consolidated. A microfiber cloth of this type combines a particularly favorable finely textured surface with a multiplicity of small pores.

Practical tests have shown that it is advantageous for the microfiber cloth to be relatively thin, since this is the way to minimize the amount of unused liquid left behind in the cloth. Against this background, the microfiber cloth advantageously has an average thickness, as measured to DIN EN 964-1, of from 0.1 to 1.0 mm, preferably between 0.3 and 0.7 mm and more preferably between 0.4 and 0.6 mm. The basis weight, as measured to DIN EN 965, is advantageously between 50 and 150 g/m², preferably between 70 and 130 g/m² and more preferably between 90 and 110 g/m².

Particularly good results are obtained when the composite filaments have a linear density of from 1.6 to 2.4 dtex, and/or when the composite filaments are at least 85%, in particular at least 90%, more preferably at least 95% split into elementary filaments and consolidated, while the linear density of the elementary filaments is preferably from 0.05 to 0.3 dtex or from 0.05 to 0.2 dtex or from 0.05 to 0.15 dtex.

The microfiber cloth is preferably one wherein the multicomponent continuous filament is a bicomponent continuous filament of two or more incompatible polymers. A bicomponent continuous filament of this type exhibits good splittability into elementary filaments and effectuates a favorable ratio of strength to basis weight. At the same time, by virtue of the polymers used and their filamentary structure, the cleaning cloth of the present invention is crease resistant, readily washable and fast-drying, i.e., easy care.

Preferably, the microfiber cloth is one wherein the composite filaments have a cross section of orange-type or pie slice multisegmented structure wherein the segments contain various, alternatingly incompatible polymers. Likewise suitable are hollow pie structures which may also have an asymmetric axial cavity.

The orange wedge and/or pie slice arrangement advantageously includes 2, 4, 8, 16, 24, 32 or 64 segments, more preferably 16, 24 or 32 segments.

The polymers used are preferably thermoplastic polymers, in particular so-called incompatible polymer pairs or blends, from various polyolefins, polyesters, polyamides and/or polyurethanes in any desired combination, which produce pairings that are preferably not, or only marginally/poorly adherent.

The polymer pairs used are more preferably selected from polymer pairs featuring at least one polyolefin, preferably featuring polyethylene, such as polypropylene/polyethylene, nylon 6/polyethylene or polyethylene terephthalate/polyethylene, or featuring polypropylene, such as polypropylene/polyethylene, nylon 6/polypropylene or polyethylene terephthalate/polypropylene. The advantage with the aforementioned synthetic materials is that these materials are inherently hydrophobic and thus highly suitable for the removal of greasy dirt. Owing to its high capillarity, the microfiber cloth is additionally capable of imbibing and releasing water, and therefore exhibits overall a very high level of cleaning performance in respect of a very wide variety of soils.

As particularly preferred components of the multicomponent continuous filament, polyesters, preferably polyethylene terephthalate, and/or polybutylene terephthalate on the one hand, polyamide, preferably nylon 6 nylon 66, nylon 46, on the other, optionally in combination with one or more further polymers incompatible with the abovementioned components, preferably selected from polyolefins, have been found to be particularly advantageous.

The cleaning cloth is further preferably one wherein at least one of the incompatible polymers forming the multicomponent continuous filament comprises polyethylene terephthalate on the one hand and a polyamide, preferably nylon 6, on the other. This combination exhibits outstanding splittability.

In one particularly preferred embodiment of the invention, a cleaning cloth as marketed under the brand name EVOLON is used.

The invention further provides a set or kit comprising the cleaning solution of the present invention and a microfiber cloth, which preferably includes the abovementioned refinements.

The liquid described may have the composition described herein. Hence the composition described in claims 12 to 21 may be used in or as a liquid as mentioned in a set as claimed in claims 1 to 11.

Furthermore, the fabric mentioned in claims 1 to 11 may be configured as a microfiber cloth as described in this description.

The sole FIGURE shows a set 1 for surface treatment, comprising textile fabric 2 and a container 3 which holds a liquid 4.

The liquid 4 comprises at least a hydrophilicizing polymer and/or at least one hydrophilicizing type of polymer, and has a pH of below 7. Concretely, the liquid 4 is formed as an acidic medium having a pH in the range between 2 and 4.5.

The textile fabric 2 comprises microfibers. The microfibers of textile fabric 2 are split by a hydroentangling process.

The microfibers consist of polyester and polyamide where the proportion of said textile fabric 2 that is polyester is more than 60 weight percent based on said textile fabric 2 in a dry state.

The hydrophilicizing polymer comprises positively charged groups. The positively charged groups are at least partly produced by protonation in an aqueous medium.

The textile fabric 2 is configured as a cloth.

The example which follows is intended to further illustrate the invention.

Example: Preparing three inventive compositions

Three compositions were prepared in the following compositions:

| | Compo- | Compo- | Compo- |
|---|---|---|---|
| | sition1 (%) | sition2 (%) | sition3 (%) |
| Mirapol S 500 | 0.7 | | |
| Mirapol S 110 | | 0.3 | |
| Mirapol S 210 | | | 1.3 |
| Lutensol XL70 | 1.0 | | |
| Lutensol XL80 | | 0.5 | |
| Glucopon 215 UP | 0.3 | | 0.6 |
| Glucopon 425 N/HH | | 0.5 | |
| Dehypon WET | | | 0.2 |
| ethanol | 5.00 | 25.00 | 5.00 |
| lactic acid | 0.5 | 1.0 | 3.5 |
| perfume | 0.10 | 0.10 | 0.10 |
| completely | ad 100% | ad 100% | ad 100% |
| ion-free water | | | |

The compositions were applied to smooth surfaces and assessed.

The compositions all developed very little foam upon application, as a result of which uniform distribution of the composition on the surface to be treated was achieved and the formation of streaks or bubbles was avoided.

The compositions of the invention provided the treated surfaces a homogeneous, uninterrupted coating which, moreover, was notable for good durability. In addition, the treated surfaces only took a very short time to dry.

The comparison showed that composition 1 endowed the treated surface with a particularly long-lasting hydrophilicizing effect, and was also very low in foam.

The advantageous aspect of composition 2 was that it likewise effectuated good hydrophilicization and was very low in foam. It applied moreover in a particularly streak-free manner to shiny surfaces.

Composition 3 was likewise low in foam and endowed many different surfaces, even plastics in some instances, with a particularly long-lasting hydrophilicizing effect.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise. Moreover, the recitation of “A, B, and/or C” or “at least one of A, B, or C” should be interpreted as including any singular entity from the listed elements, e.g., A, any subset from the listed elements, e.g., A and B, or the entire list of elements A, B, and C.

1. A set for surface treatment, the set comprising:
a textile fabric; and
a container which holds a liquid,
wherein the liquid comprises a hydrophilicizing polymer, and
wherein the liquid has a pH of below 7.

2. The set of claim 1, wherein the textile fabric comprises microfibers.

3. The set of claim 2, wherein the microfibers are produced by a splitting process.

4. The set of claim 2, wherein the textile fabric comprises microfibers of a material comprising a polyester, polyamide, or combination of two or more of these.

5. The set of claim 4, wherein a proportion of the textile fabric that is polyester is more than 60 wt. %, based on a total weight of the textile fabric in a dry state.

6. The set of claim 1, wherein the hydrophilicizing polymer comprises a positively charged group.

7. The set of claim 6, the positively charged group is at least partly produced by protonation in an aqueous medium.

8. The set of claim 1, wherein the pH of said liquid (4) is between 2 and 5.

9. The set of claim 1, wherein the textile fabric (2) is configured as a cloth.

10. The set of claim 1, wherein the liquid (4) is sufficiently acidic for nearly the entire polymer to be available for the surface to be treated.

11. A method of treating a surface, the method comprising:
applying the liquid of the set of claim 1 to a surface to be treated, and
distributing the applied liquid using the textile fabric.

12. A composition,. comprising:
a) 0.05-1 wt % of a hydrophilicizing copolymer comprising, in the form of polymerized units, (i) an amino-functional monomer having a permanent cationic charge or capable of forming a cationic charge by protonation, and (ii) an acidic monomer having a permanent anionic charge or capable of forming an anionic charge;
b) 0.5 to 1.4 wt % of a nonionic surfactant;
c) 1 to 10 wt % of a solvent;
d) a balance of water.

13. The composition of claim 12, wherein the surfactant has a foam volume below 400 mL, as per EN 12728 (1 g/L, 20° C., 30 s, demin. water).

14. The composition of claim 12, wherein the surfactant comprises an alcohol alkoxylate comprising 8-15 carbon atoms.

15. The composition of claim 12, wherein the surfactant comprises a mixture comprising an alcohol alkoxylate and an alkylpolyglycoside.

16. The composition of claim 15, wherein ratio between alcohol alkoxylate and alkylpolyglycoside is from 3:1 to 1:2.

17. The composition of claim 12, having a proportion of surfactant in a range of from 0.1 to 1.3 wt. %.

18. The composition of claim 12, wherein the hydrophilicizing copolymer comprises a quaternized ammonium/acrylamide/acrylic acid copolymer.

19. The composition of claim 12, having a proportion of hydrophilicizing copolymer in a range of from 0.05 to 0.5 wt %.

20. The composition of claim 12, having a weight ratio of surfactant to hydrophilicizing copolymer between 2 to 1 and 50 to 1.

21. The composition of claim 12, comprising an acid in an amount sufficient to provide the composition a pH in a range of from 2 to 5.

22. A set, comprising:
the composition of claim 12; and a microfiber cloth.

23. A method of treating a hard surface, the method comprising:
contacting the composition of claim 12 to the hard surface.

24. A method of cleaning an object, the method comprising:
contacting the object with the composition of claim 12, using a microfiber cloth.

25. The method of claim 24, wherein the microfiber cloth comprises melt-spun, aerodynamically attenuated composite filaments having a linear density of 1.5 to 3 dtex and directly laid down to form a nonwoven web, and
wherein at least 80% of the composite filaments are split into elementary filaments having a linear density of 0.05 to 1.0 dtex and consolidated.

26. The method of claim 24, wherein the microfiber cloth has a basis weight, as measured to DIN EN 29073, in the range of less than 150 g/m².
